(19) United States
(12) Patent Application Publication
(10) Pub. No.: US 2017/0297086 A1
(43) Pub. Date: Oct. 19, 2017

(54) PROCESS FOR PROVIDING METAL CASTINGS USING THE LOST FOAM METHOD

(71) Applicant: Mark DeBruin, Tipp City, OH (US)

(72) Inventor: Mark DeBruin, Tipp City, OH (US)

(21) Appl. No.: 15/175,356

(22) Filed: Jun. 7, 2016

Related U.S. Application Data
(63) Continuation-in-part of application No. 15/131,379, filed on Apr. 18, 2016, now abandoned.

(51) Int. Cl. B22C 9/04; B33Y 80/00; B22C 1/04; B22D 30/00; B22D 29/00; B22D 25/02; B22D 15/00; B33Y 10/00; B22C 9/24; B22C 9/18; B22C 9/08; B22C 7/02; B22C 1/14; B22C 21/00; B29K 67/00; B29K 105/04; B29L 31/00

(52) U.S. Cl. CPC B22C 9/046; B22C 21/00; B33Y 80/00; B22C 1/04; B22D 30/00; B22D 29/00; B22D 25/02; B22D 15/00; B33Y 10/00; B22C 9/24; B22C 9/18; B22C 9/082; B22C 7/026; B22C 1/14; B29K 2067/046; B29K 2105/04; B29L 2031/757

(57) ABSTRACT

3-D printed PLA material of a selected density is formed into a pattern that is configured as the outer shell of a casting form to be used in the lost foam or evaporative casting process. The purpose of 3-D printing of the PLA material is used to maintain the proper configuration of the form to facilitate casting, and reduce buildup of carbon on the surface of the casting. Because the form is essentially hollow, PLA support pieces can be used on the interior to maintain the structural integrity of the form.

### RELATED APPLICATIONS

This is a continuation-in-part application of U.S. patent application Ser. No. 15/131,379, filed Apr. 18, 2016, by the same inventor.

### FIELD OF INVENTION

The present invention concerns the field of metal casting. It includes higher melting point metals, especially such materials as iron, steel, aluminum, brass, and zinc. In particular, the present invention is directed to the use of new materials and techniques for manufacturing forms or patterns to be used in casting processes based upon the conventional “lost foam” or evaporative method.

### BACKGROUND ART

Metal parts from such materials as aluminum, brass, iron and steel, can be made using a variety of methods, including: machining; green sand casting; resin bonded sand mold casting; and, investment casting. Problems and limitations with these methods require tradeoffs in manufacturing time, cost, tolerances, and additional post-casting processing, such as cleaning and machining.

The lost foam or evaporative method of casting (Appendix II) conventionally uses expanded polystyrene (EPS) or a combination of EPS and poly methyl (methacrylate) (PMMA) as forms. This method solves many of the conventional problems, by requiring less manufacturing time (for both the form and the casting), resulting in lower costs. Also, this method achieves high “as cast” tolerances so that no, or minimal, additional machining is required. The result is a superior product.

One example of a modified use of the lost foam method is found in U.S. Pat. No. 8,136,571, issued to the inventor of the present invention on Mar. 20, 2012. Aside from the modifications constituting the invention of the subject patent, other aspects of the process are the same as conventional lost foam processes.

In the lost foam method, a form or pattern is made of expanded polystyrene (EPS), or a similar material. Conventionally, a single layer of standard refractory coating is applied to the EPS form. Usually, such coatings are water-soluble, and take no part in any other reaction that occurs when the metallic melt is applied. The standard coating is formulated to permit the escape of gases that form during vaporization of the foam. The coated form is placed in a sand chamber which serves as a mold. The sand is compacted or otherwise handled in a manner conventional to the lost foam process. The sand is constituted by a dry, mined, and screened product, with no additives. In place of natural sand, synthetic sand comprised of ceramic spherical particles can also be used.

As is typical with the lost foam method, the metal pour is applied directly to the area of the EPS form (using a spout). The polystyrene is vaporized and replaced by the molten metal. The handling of the molten pour and the cooling of the casting are both well known, as are the remaining steps of removing the solidified metallic casting from the sand and cleaning it.

A major problem with the lost foam or evaporative casting method occurs when using iron alloys, and in particular, steel. For example, EPS and other polymers currently utilized in the evaporated foam pattern are constituted by hydrocarbons. For example, Polystyrene is a polymer comprised of (C₈H₈)ₙ which results in the formation of water vapor, carbon, and other hydrocarbons when it is vaporized by the molten metal. Some of the carbon becomes carbon dioxide and escapes through the refractory coating, but some goes into solution with the molten metal. This distorts the molten metal composition. For some alloys this characteristic makes the use of the lost foam casting with EPS unfeasible, since more carbon will go into solution than is permitted by material specifications for the cast product.

In addition to distorting the alloy composition, which directly controls the material properties of the casting, the additional carbon can result in a product known as lustrous carbon. Lustrous carbon is a defect whereby so much carbon is added that it is no longer entirely in solution. As a result, a film of graphite forms upon solidification of the metal casting. This graphite layer is much weaker than the iron or steel and can result in macroscopic surface defects easily visible to the naked eye. These defects cannot be repaired by welding, and if a defect is deeper than the permitted machining level, the cast part is then considered scrap.

Another problem with the conventional art is that the foam patterns, or forms, are generally manufactured by expanding the foam material in dies on foam expansion machinery. As with most precision tooling, the manufacture of these dies is expensive. While this is acceptable when extremely large runs of the foam are to be produced, precision tooling is economically unsustainable when only small runs of the forms are contemplated. These economical limitations also lead to the additional problem of limited form manufacturing capability for prototypes, especially those that have to be developed quickly.

There are a number of other manufacturing techniques for creating foam forms or patterns for metal casting. Unfortunately, all of these involve trade-offs of material suitability versus manufacturing time, versus final product precision, versus cost.

Other casting techniques are also available. One of the most common is known as the “lost wax” technique, or investment casting (Appendix I). Traditionally, a wax form was used in this type of casting. The form was covered by multiple layers of ceramic coating, each of which was dried between each application, until a robust solid form was achieved. The wax was melted and evacuated from the solid form before the metal pour was made. When the investment casting technique is used with polystyrene it is necessary for the foam form to be disintegrated, evaporated, or otherwise removed before making the metal pour. This process adds manufacturing steps and difficulty, creating a whole new set of problems and expenses.

One type of foam material currently used as a form or pattern material with the lost wax casting method is polylactic acid (PLA). This material is expensive to use, and is most commonly used in 3-dimensional printed solid shapes, rather than blown foam. Use of PLA appears to be most popular with hobbyist, experimenters, and other entities engaged in limited runs of a particular casting. This is exemplified by conventional art citations attached to the present application.

However, there are certain difficulties with this particular combination of form type and casting method (lost wax). In particular, the PLA must be sufficiently dense enough to withstand all further processing in the casting process. The result of high density PLA form is the resulting high amount of vapor that will evolve from the current forms used, especially when the PLA form is incinerated before introducing the molten metal for casting. This removal or burn out requirement creates a whole set of problems, including additional manufacturing steps, and the necessity of extremely thick refractory coatings, built up by several steps of application, such as dipping and drying. In particular, the thick refractory coating must be heated to high temperatures to successfully cast iron and steel parts. This is just one of the many difficulties of this approach. In many instances, the additional processing steps render this combination of form material and casting method unsuitable for many types of manufacturing situations.

While 3-D printing has made the creation of PLA forms much more economical in recent years (as indicated by the URL's cited in the attached Information Disclosure Statement), the aforementioned difficulties regarding the operation of the lost wax casting process have not been overcome. In particular, multiple refractory coating steps are required. Each of these applications has to be followed up by a drying period, to eventually obtain the necessary thickness of the refractory coating. Further, the coating has to be heated to relatively high temperatures to melt the wax which is usually evacuated for reuse before the metal is introduced for casting.

The empty ceramic shape formed from the refractory coating is then reheated so as to be red-hot, and closer in temperature to the molten metal that is to be introduced. After the molten metal is poured and solidifies, the mold material formed from the refractory coating is removed either by a waterjet or mechanical chipping. All of these additional processing steps require time and resources.

In contrast, the lost foam method requires only a single thin layer of refractory coating over the foam form or pattern. The pattern or form is placed in loose sand which is vibrated to flow around the form and fill in all the spaces tightly. The molten metal is poured directly onto the foam, which vaporizes at the same moment the metal is introduced. To remove the metal casting from the system, the sand is poured out of its container, and most of the refractory coating falls away from the casting. The remaining coating is easily removed with standard shot blasting. Clearly, the lost foam method is much faster and less expensive.

The parent patent application Ser. No. 15/131,379 filed on Apr. 18, 2016, discloses a method by which a blown PLA form can be used with the lost foam method. It is noted that until the advent of this inventive process, the use of PLA material with the lost foam method was entirely impractical. While the subject invention solves many of the aforementioned problems, it is still not ideal since 3-D printed forms cannot be used with the inventive arrangement. The increasing development of 3-dimensional printing to provide casting patterns or forms still cannot be exploited by current casting methods, including the one disclosed in the cited patent application.

Accordingly, there is a substantial need for providing a system to cast iron and steel parts with PLA forms created by 3-dimensional printing, without the drawbacks of conventional systems. Such a system would not require additional manufacturing steps during the casting process, thereby avoiding additional manufacturing complications

There is also a need to produce a form or pattern for such a system without incurring the expense of precision tooling while still producing reasonably well finished metal parts.

### SUMMARY OF INVENTION

It is the primary object of the present invention to overcome the conventional difficulties of lustrous carbon defects in iron and steel castings produced by the lost foam method.

Another object of the present invention is to be able to control the carbon content of the molten iron or steel alloy such that the required compositions are achieved.

It is a further object of the present invention to provide a method of forming a pattern that is timely and cost effective when producing a small number of particular finished castings.

It is an additional object of the present invention to provide a metal casting that can be used in an “as-cast” state, with little or no additional machining.

It is still another object of the present invention to provide a system wherein precise casting of ferrous and nonferrous metals can be made quickly and inexpensively.

It is yet a further object of the present invention to provide a method of casting that eliminates manufacturing steps, especially those associated with pre-casting preparation.

It is again an additional object of the present invention to provide a casting method that avoids generating additional, harmful byproducts.

It is still another object of the present invention to provide a casting method that limits the requirements of the refractory coating that is placed on the form or pattern before the molten metal is introduced.

It is yet a further object of the present invention to provide a method of casting that facilitates ease of removal of the refractory coating from the casting.

It is again an additional object of the present invention to provide a casting method that does not rely upon precision techniques in the manufacture of the patterns or forms used in the casting process.

It is yet another object of the present invention to quickly and inexpensively produce patterns for a wide variety of metal castings.

It is still a further object of the present invention to provide a system and a process wherein the lost foam method can be used with PLA patterns or forms manufactured by the 3-dimensional printing process.

It is yet an additional object of the present invention to provide a casting process that can fully utilize a wide array of different 3-dimensional printed forms, including hollow and semi-hollow forms.

These and other objects and goals of the present invention are achieved by a process to obtain a casting having predetermined characteristics, using a polylactic acid (PLA) form in the lost foam method. The process includes the steps of 3-dimensional printing polylactic acid material into a body having a density between 10 and 20 lbs. per cubic foot. The body is configured in accordance with the predetermined characteristics to obtain a final casting form. The final casting form is placed in a container, and surrounded with sand. Then, the molten metal is applied to the form within the container, thereby vaporizing the final casting form to obtain the casting.

### BRIEF DESCRIPTION OF DRAWINGS

FIG. 1 is a flow diagram depicting the various steps of creating the final product when a PLA form is made by 3-dimensional printing.

FIG. 2A is a perspective diagram of a substantially hollow form made using a 3-dimensional printing process.

FIG. 2B is a detailed perspective view of an enlarged portion of the cross section of the form of FIG. 2A.

### DETAILED DESCRIPTION OF PREFERRED EMBODIMENTS

The key to achieving metal casting using the evaporative or lost foam method, without substantial carbon accumulation, is the utilization of polylactic acid (also known as PLA or polylactide) as forms or patterns. PLA is a polymer with a formula of (C₃H₄O₂)ₙ, rather than the conventionally used polymer polystyrene which is comprised of (C₈H₈)ₙ or poly(methyl methacrylate) which is (C₅O₂H₈)ₙ. The oxygen in the polymer makes it easier for the polymer to decompose into water and carbon dioxide. It also starts with less carbon in the first place meaning that there is less available for dissolution into the molten metal. This is a crucial issue in iron and steel casting.

The use of PLA in the lost wax casting method is already well-known, as indicated in the Information Disclosure Statement accompanying the present application and the parent application. However, in many applications, the lost wax method is either inappropriate, or substantially inferior to other methods, such as the lost foam method.

Prior to the invention disclosed in the parent application (U.S. patent application Ser. No. 15/131,379 filed on Apr. 18, 2016) to the same inventor as the present application, PLA was not known to have been previously used for evaporative or lost foam casting. This was a result of PLA being a relatively recently developed biopolymer, and its used for pattern material was also very recent due to the higher cost than those found for conventional lost foam polymer materials. The use of blown PLA patterns or forms for use in the lost foam casting method is fully disclosed in the parent application. The inventive system of the parent application makes use of PLA blown foam in a very efficacious manner. However, there are limitations in the use of blown foam as casting patterns.

The advantage of both the inventions of the parent application and the present application resides in the use of the lost foam or evaporative casting process. This process is radically different from the lost wax process in which PLA has been previously used. In particular, the lost foam method requires only a single, thin layer of refractory coating, rather than multiple thick coatings required by the lost wax method. The refractory coating, when used in the lost wax method, must be highly heated to disintegrate the PLA foam pattern. This is costly, and involves multiple awkward coating steps that are avoided by the present invention. Further, removal of the thick refractory coating layer after the casting has been carried out involves far greater effort than with the lost foam method of the present application and the parent application. With the present invention, removal of the sand support is usually sufficient to cause refractory coating the fall away from the casting.

As effective as the invention of the parent application is, there are situations in which blown foam is not appropriate for the type of casting desired. In some situations, relatively complex structures are needed to constitute the form or pattern used in the casting. Further, blown foam is often very difficult to place in a finished shape without extensive and time-consuming modifications of the blown foam casting pattern. Also, blown PLA foam is often lacking sufficient structural capability of the form required by product being lost.

The key advantage of the present invention is that it uses 3-D printed PLA forms or patterns for use in the lost foam casting process. 3-D printing is constantly improving in speed, complexity, and effectiveness, while continuously dropping in cost. This is a substantial advantage in the metal casting technology.

The product produced by 3-D printing is substantially different than that produced by blown PLA foam. Accordingly, 3D printed PLA forms were not considered appropriate for the lost foam casting process until now. By finding a method of using 3-D printed PLA material in the lost foam method, the advantages of 3-D printing can be achieved. These include a larger, more complex structures to be used as patterns or forms. The increased strength of the 3D printed PLA forms of the present invention is due to the fact that the PLA pattern is not a foam, but rather a structure with mesh and air gaps. However, the outside surface is essentially solid so as to permit the necessary refractory coating step.

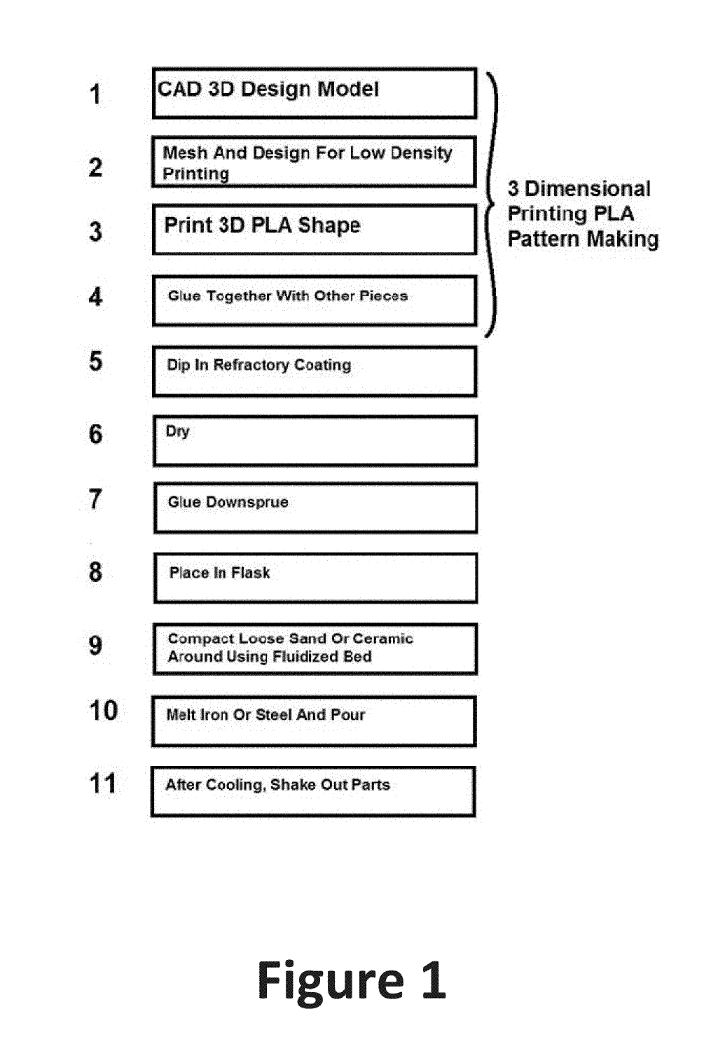

Referring to FIG. 1, a model of the desired pattern form, or a part thereof, is developed using a computer aided design (CAD) program (step 1). The fact that such programs can be developed for a wide variety of parts, and then quickly put into manufacture is one of the key advantages of using 3-D printed forms with the lost foam method. The CAD file is then converted into a file that a 3-D printer can use, such as an STL file. At step 2, a mesh pattern for the particular type of form desired is programmed into the 3-D printer. At step 3, the 3-D printing is carried out. This type of manufacture is increasingly inexpensive, as well as increasingly fast. This is especially true with relatively low density final products (in the ranges of between 10 and 20 lbs. per cubic foot for the present invention).

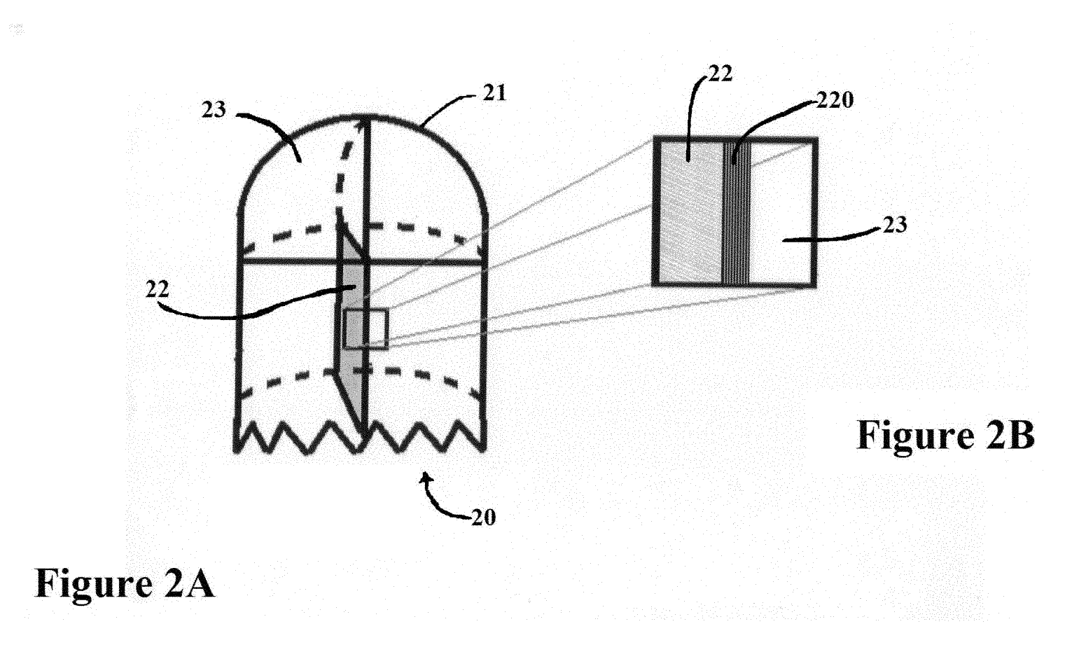

The PLA form or pattern, of the present invention (as constituted by means of 3-dimensional printing), must have a density between 10 and 20 lbs. per cubic foot to be used in the lost foam casting process. Preferably, the form or pattern is manufactured as a single piece, and is at least partially hollow. An example of such a structure is depicted in FIGS. 2A and 2B, a hollow structure, reinforced with internal bracing structures.

FIG. 2A is a perspective view of the 3-D printed PLA structure. The structure is mostly hollow, encompassing space 23 inside of outer shell 21. The outer shell 21 is reinforced by interior bracing structure 22, which is shown in greater detail in the FIG. 2B. FIG. 2B depicts the increased density of cross-section 220. This is provided for increased reinforcing of the overall structure of form 20 to withstand the stresses created by the hot metallic pour, and the back gas pressure generated when the printed PLA material evaporates. Appendix III includes a number of photographs of different views of form 20, and a final casting produced by such a form.

The casting and form 20 photographed in Appendix III depict a form with an exterior up to 0.125 inches thick. The inside reinforcing structure 22 is 0.1 mm thick. By using the 3-D printed method, the thicknesses and mesh configurations can be adjusted for different parts of the form. In this manner, denser PLA material can be used at crucial structural junctions, such as the one depicted by 220 in FIG. 2B.

Such castings as the one depicted in Appendix III have been made in steel, cast iron, and a variety of special alloys of cast-iron. The casting is approximately 2 inches tall, with a 1 inch outer diameter. Such pieces had been cast successfully in gray iron and in 8620 steel. The pour temperature for the steel was at least 2950° F., and in iron was at least 2600° F. with a fill rate of 100 pounds per second. The PLA 3-D printed form at a density of 13.2 lbs. per cubic foot.

Other castings have been done with high phosphorus gray iron and a pour temperature of 2675° F. This process used a pour rate of approximately 125 pounds per second. The outer circumference of the casting was approximately 3 inches. The 3-D printed PLA form for this second type of casting had a density of approximately 18.9 lbs. per cubic foot.

At step 4 in FIG. 1, the pieces of 3-D printed PLA forms are glued together. However, this may not be necessary if the entire form or pattern can be constituted by a single 3-D printing, as shown in Appendix III. One advantage of the present invention, and the use of 3-D printed PLA forms is that minimum machining is usually required. This is in contrast to the extensive machining that is usually carried out when low density PLA forms are used, such as in the parent application. Because 3-D printing of PLA forms is becoming faster, and exhibits greater flexibility, the final assembly of the final casting form will be simplified with the present invention. If a complex form can be generated with one 3-D printing of PLA, the overall casting process is substantially facilitated, and the cost can drop substantially.

Before the metal melt is applied to the body of the 3-D printed PLA form, a standard refractory coating is applied (step 5). Usually such coatings are water-soluble, and are designed to permit the escape of the gases that evolve and prevent mold wall collapse. Such coatings are standard in the well-developed art of lost foam casting, and need no further elaboration for purposes of the present invention. With the present invention, the refractory coating is expected to be very thin. This is a substantial distinction from the use of refractory coatings in the lost wax method, where the coatings are expected be extremely thick, and to constitute the form structure after the original form material (either wax or foam) is removed by heating of the thick refractory layer. The system of the present invention avoids these costly, and time-consuming steps.

Once the refractory coating has dried (step 6), thereby coating the entirety of the PLA form, the PLA form is glued to a downsprue (step 7), a funnel or spout constituted by refractory material. The molten metal will eventually enter the form system through this funnel. The PLA form and downsprue, referred to as a cluster, are set on a bed of sand in a large vessel referred to as a flask (step 8).

Additional sand is poured into the vessel (step 9), while vibrating so that the sand is fluidized and fills in all of the spaces around the PLA form. This is referred to as compacting the sand since the sand is packed into a tight rigid form as a result of the vibration. The sand, used for both filling and compaction (step nine), can be standard, un-bonded sand or man-made fine-grained ceramic. These are the materials normally used for compaction in the lost foam casting process. The sand used is dry and differentiated from traditional foundries (those not using the lost foam casting method). Such foundries use “green sand” or “resin sand”, which is wet sand constituted by a mixture of water, clay and other additives, or a plastic resin bonded sand.

A key difference is that by using the lost foam technique, a much smoother surface is obtained than that obtained using other casting methods. As a result, substantial post-casting machining of the cast part is not necessary. The use of dry sand with the lost foam method is crucial to obtaining the desired surface characteristics of the casting. In contrast, wet sand or plastic resin results in mold wall movement, and the evolution of gases which can distort dimensions of the casting.

At step 10, the molten iron or steel (or other metal) is poured into the downsprue which connects to the PLA form. The PLA is then vaporized and replaced by the molten metal. The handling of the molten pour and the cooling of the casting are well-known in this technology. However, there are distinctions between the use of PLA and traditional expanded polystyrene (EPS). In particular, when using a PLA form, the metal must be hotter and poured faster than with EPS. This is due to a greater density of the PLA material, requiring greater heat to vaporize it.

If the PLA form is too dense and expansive for the temperature and pour rate, the molten metal will not have sufficient heat to vaporize it. As a result, the metal pour will freeze prematurely resulting in the polymer burning rather than vaporizing. If the PLA form is too dense, but not so dense as to freeze the metal, the amount of gas that evolves can be such that it does not escape through the refractory coating and sand, but that it explodes back up the downsprue where operators are pouring molten metal, thereby endangering them.

Even if the back pressure from the gas created by the evaporating PLA does not force an explosion back up the downsprue, there are still other drawbacks if the proper parameters are not maintained for the pour. In particular, if the form is complex, or has substantial extensions, the casting could be abbreviated at such extensions. This is due to the amount and density of the PLA material creating an amount of gas back pressure that cannot be overcome by the temperature and pour rate of the molten metal being applied to the downsprue. Accordingly, it is necessary to match the density and amount of 3-D printed PLA to the temperature and pour rate of the metal.

In general, the present invention operates for steel at a minimum temperature of 2900° F., with a speed of 30 lbs. per second to 150 lbs. per second. For iron, the temperature is between 2400° F. and 3000° F., with a pour speed of between 30 and 150 lbs. per second. The size of the castings range between 0.3 lbs. to approximately 75 lbs. Accordingly, it is necessary that the metal have a high enough melting point, and the melt contain enough heat to properly vaporize the PLA form or pattern. It is necessary that the PLA pattern be of an appropriate density so that it is thoroughly vaporized by the molten metal being applied thereto.

The refractory coating must be sufficiently strong to prevent the mold wall from collapsing during the vaporization process, before the foam is entirely vaporized and replaced with liquid metal. The loose sand or man-made fine grain ceramic must be fluidized in such a way as to compact it tightly and prevent mold wall collapse. However, the refractory coating must not be so thick as to prevent the vaporized gas from escaping.

The metals that may be used in the processes, as depicted in FIG. 1, include: aluminum; brass; zinc; and a variety of iron and steel formulations. Essentially, any metal with a melting point over 800° F. is sufficient to vaporize the PLA, if enough heat is present. Not only must it be enough heat to burn out the PLA, but sufficient heat must remain to maintain the temperature necessary to form a good casting where it must solidify. If there is insufficient heat, there will be defects in the casting.

The shakeout of the casting (step 11) occurs when the casting is removed from the flask or container, and the sand shaken away from the casting. The refractory coating (applied at step five) is removed using a variety of different conventional techniques. One such example is shot blasting, which provides an efficient method of cleaning the refractory coating from the casting, as well as providing further smoothing of the casting surface. It should be understood that other types of cleaning and smoothing techniques can be used to remove both the cleaning sand and the refractory coating.

It should be understood that the standard refractory coatings can be used for various irons and steels that can be cast using the lost foam method. Refractory coatings are water-based with an organic component so that they will congeal very quickly on a wide variety of different types of PLA surfaces. This is especially important for controlling the coating thickness. Once the water is dried away (step six), the actual coating remaining on the form can be graphite, zircon, perlite, marshalite, or other ceramics and/or sands. All of these coating materials can be adjusted in composition and thickness for the particular metal being cast.

While a number of embodiments of the present invention have been described by way of example, the present invention is not limited thereto. Rather, the present invention should be understood to include any and all variations, permutations, adaptations, derivations, modifications and embodiments that would occur to one that is skilled in this art and in possession of the teachings of the present invention. Accordingly, the present invention should be construed as being limited only by the following claims.

1. A process to obtain a casting having predetermined characteristics, using a polylactic acid (PLA) form in the lost foam method; said process comprising the steps of:
a) 3-dimensional printing of polylactic acid material into a body formed entirely of polylactic acid and having a density between 10 and 20 pounds per cubic foot so that said body is configured in accordance with said predetermined characteristics to obtain an outer shell of a final casting form;
b) placing said final casting form in a container and surrounding said final casting form with sand; and,
c) applying molten metal to said final casting form within said container, thereby vaporizing said final casting form to obtain said casting.

2. The process of claim 1, wherein the step of configuring includes
i) providing internal support to said outer shell using polylactic acid support pieces.

3. The process of claim 2, wherein the step (a) of configuring further includes
ii) gluing said polylactic acid support pieces together to support for said final casting form.

4. The process of claim 3, wherein step (a) of configuring further includes
iii) applying a refractory coating over said final casting form.

5. The process of claim 4, wherein step (b) of placing includes using un-bonded, natural or man-made sand.

6. The process of claim 5, wherein step (b) of placing further includes gluing a sprue to said final casting form to receive molten metal directed to said final casting form.

7. The process of claim 6, wherein step (b) of placing further includes compacting said sand.

8. The process of claim 7, further comprising the step of:
e) cooling and shaking out said metal casting from said sand.

9. (canceled)

10. (canceled)

11. The process of claim 4, wherein said sub-step (iii) of applying refractory coating comprises dipping said final casting form into material comprising said refractory coating.

12. The process of claim 11, wherein at step (c) of adding molten metal, said vaporized form is evacuated through said refractory coating.

13. The process of claim 1, wherein said final casting form is substantially hollow.

14. The process of claim 13, wherein said final casting form contains at least one polylactic acid support piece extending across a width of said final casting form.

15. The process of claim 14, wherein said final casting has an exterior wall up to 0.125 inches thick.

16. The process of claim 1, wherein said molten metal is steel, having a minimum pour temperature of 2900° F., and a pour rate of between 5 and 150 lbs. per second.

17. The process of claim 1, wherein said molten metal is iron, having a pour temperature between 2400° F. and 3000° F., with a pour rate of between 5 to 150 lbs. per second.
